(19) United States
(12) Patent Application Publication
(10) Pub. No.: US 2026/0070538 A1
(43) Pub. Date: Mar. 12, 2026

(54) VEHICLE LOCALIZATION SYSTEM AND METHOD

(71) Applicant: Rivian IP Holdings, LLC, Irvine, CA (US)

(72) Inventors: Hien NGUYEN, Tustin, CA (US); Ke SUN, Monterey Park, CA (US); Bhuvanesh SAINATH, Irvine, CA (US); Ghazaale LEYLAZ MEHRABADI, Redwood City, CA (US)

(21) Appl. No.: 19/320,417

(22) Filed: Sep. 5, 2025

Related U.S. Application Data
(60) Provisional application No. 63/691,982, filed on Sep. 6, 2024.

(51) Int. Cl. B60W 30/02; B60W 40/10; G01C 21/16

(52) U.S. Cl. CPC B60W 30/02; B60W 40/10; G01C 21/165; B60W 2520/26; B60W 2520/28

(57) ABSTRACT

A vehicle control system a plurality of neural networks that are used to calculate a plurality of wheel slip estimates for a plurality of wheels based on wheel speed measurements for each wheel and outputs from other sensors of the vehicle, such as an IMU or GNSS receiver. Separate neural networks estimate wheel slip for each wheel. Wheel slip estimates may be used to select wheel speed measurements that are used to update a Kalman filter. The Kalman filter further updates its state according GNSS measurements that are not rejected according to a rejection algorithm that includes shape matching with respect to a trajectory estimated by the Kalman filter.

### CROSS-REFERENCE TO RELATED APPLICATIONS

This application claims priority to and benefit of U.S. Provisional Patent Application No. 63/691,982, filed Sep. 6, 2024, the content of which is incorporated herein by reference in its entirety.

### INTRODUCTION

The present disclosure relates to a vehicle localization system and method.

### SUMMARY

In one aspect, a method includes calculating, by a control system, a plurality of wheel slip estimates for a plurality of wheels of a vehicle based on a plurality of wheel speed measurements using a plurality of neural networks by. For example, for each wheel of the plurality of wheels of the vehicle, the control system may receive a wheel speed measurement of the plurality of wheel speed measurements derived from an output of a wheel speed sensor of the each wheel. The control system processes the wheel speed measurement with one or more sensor outputs of the vehicle with a neural network of the plurality of neural networks corresponding to the each wheel to obtain a wheel slip estimate of the plurality of wheel slip estimates corresponding to the each wheel. The control system controls operation of the vehicle according to the plurality of wheel slip estimates.

In some embodiments, the one or more sensor outputs include outputs of an inertial measurement unit. In some embodiments, the one or more sensors outputs include global navigation satellite system (GNSS) data. In some embodiments, the one or more sensor outputs include both of outputs of an inertial measurement unit (IMU) and global navigation satellite system (GNSS) data.

In some embodiments, each neural network of the plurality of neural networks each includes eight or less layers. In some embodiments, each neural network of the plurality of neural networks includes six layers. In some embodiments, each neural network of the plurality of neural networks is a multi-layer perceptron (MLP). In some embodiments, the MLP of each neural network of the plurality of neural networks includes a customer layer before a sigmoid layer, the customer layer configured to carry information from a previous prediction as a hidden state to a current prediction of the MLP of each neural network of the plurality of neural networks.

In some embodiments, controlling operation of the vehicle according to the plurality of wheel slip estimates comprises processing one or more wheel speed measurements of the plurality of wheel speed measurements using a Kalman filter, the one or more wheel speed measurements being selected from the plurality of wheel speed measurements according to the plurality of wheel slip estimates. In some embodiments, selecting, by the control system, the one or more wheel speed measurements according to plausibility of the plurality of wheel speed measurements with respect to a vehicle speed output from the Kalman filter, the plurality of wheel slip estimates, and closeness of the plurality of wheel speed measurements to the vehicle speed output from the Kalman filter.

In another aspect, a vehicle control system is configured to calculate a plurality of wheel slip estimates for a plurality of wheels of a vehicle based on a plurality of wheel speed measurements using a plurality of neural networks. For each wheel of the plurality of wheels of the vehicle, the vehicle control system receives a wheel speed measurement of the plurality of wheel speed measurements derived from an output of a wheel speed sensor of the each wheel. The vehicle control system processes the wheel speed measurement with one or more sensor outputs of the vehicle with a neural network of the plurality of neural networks corresponding to the each wheel to obtain a wheel slip estimate of the plurality of wheel slip estimates corresponding to the each wheel. The vehicle control system controls operation of the vehicle according to the plurality of wheel slip estimates.

In some embodiments, the one or more sensor outputs include outputs of an inertial measurement unit. In some embodiments, the one or more sensors outputs include global navigation satellite system (GNSS) data. In some embodiments, the one or more sensor outputs include both of outputs of an inertial measurement unit (IMU) and global navigation satellite system (GNSS) data.

In some embodiments, each neural network of the plurality of neural networks each includes eight or less layers. In some embodiments, each neural network of the plurality of neural networks is a multi-layer perceptron (MLP). In some embodiments, the MLP of each neural network of the plurality of neural networks includes a customer layer before a sigmoid layer, the customer layer configured to carry information from a previous prediction as a hidden state to a current prediction of the MLP of each neural network of the plurality of neural networks.

In some embodiments, the vehicle control system is further configured to control operation of the vehicle according to the plurality of wheel slip estimates by processing one or more wheel speed measurements of the plurality of wheel speed measurements using a Kalman filter, the one or more wheel speed measurements being selected from the plurality of wheel speed measurements according to the plurality of wheel slip estimates. In some embodiments, the vehicle control system is further configured to select the one or more wheel speed measurements according to plausibility of the plurality of wheel speed measurements with respect to a vehicle speed output from the Kalman filter, the plurality of wheel slip estimates, and closeness of the plurality of wheel speed measurements to the vehicle speed output from the Kalman filter.

In another aspect, a vehicle includes a plurality of wheels; a plurality of wheel speed sensors each configured to sense a speed of a wheel of the plurality of wheels; and one or more other sensors including one or more of an inertial measurement unit (IMU) or a global navigation satellite system (GNSS) receiver. The vehicle includes a control system including a plurality of neural networks. The control system configured to calculate a plurality of wheel slip estimates for the plurality of wheels using the plurality of neural networks. For each wheel of the plurality of wheels, the control system receives a wheel speed measurement derived from an output of a wheel speed sensor of the each wheel. The control system processes the wheel speed measurement with outputs of the one or more other sensors with a neural network of the plurality of neural networks corresponding to the each wheel to obtain a wheel slip estimate of the plurality of wheel slip estimates corresponding to the each wheel. The control system controls operation of the vehicle according to the plurality of wheel slip estimates.

### BRIEF DESCRIPTION OF THE DRAWINGS

FIG. 1A illustrates an example vehicle in accordance with certain embodiments.

FIG. 1B illustrates a chassis of a vehicle in accordance with certain embodiments.

FIG. 2A is a schematic block diagram of a control system of a vehicle in accordance with certain embodiments.

FIG. 2B is a schematic block diagram of an alternative control system of a vehicle in accordance with certain embodiments.

FIG. 3 illustrates a system for training a machine learning model to detect wheel slip in accordance with certain embodiments.

FIG. 4 illustrates a machine learning model for detecting wheel slip in accordance with certain embodiments.

FIG. 5 illustrates a system for selecting which wheel speed measurement to use to update a Kalman filter.

FIG. 6 illustrates a method for rejecting GNSS measurements in accordance with certain embodiments.

FIGS. 7A and 7B illustrate rejection of GNSS measurements in accordance with certain embodiments.

FIG. 8 illustrates a localization state machine for determining how to operate a Kalman filter in accordance with certain embodiments.

FIG. 9A illustrates components supplying inputs to and receiving outputs from a localization software controller in accordance with certain embodiments.

FIG. 9B illustrates a localization software controller in accordance with certain embodiments.

### DETAILED DESCRIPTION

In the evolving landscape of electric vehicle (EV) engineering, the demand for sophisticated vehicle control systems has surged. EVs, equipped with high-fidelity torque control capabilities, outperform internal combustion engine (ICE) vehicles in terms of precise and responsive control. This superior capability necessitates advanced state estimation algorithms to fully leverage EV powertrains. Many applications benefit from accurate localization in order to determine vehicle states such as attitude, velocity, and position.

An approach for performing vehicle localization is disclosed herein that integrates data from common sensors, such as wheel speed sensor, steering angle sensor, inertial measurement unit (IMU), and a global navigation satellite system (GNSS), to provide accurate and reliable state estimation across various driving conditions. The approach herein facilitates localization for vehicle control and navigation even in cases where some sensor data does not accurately reflect the vehicle state or is not available, such as when driving on off-road terrain (e.g. sand, rocks) or low friction surface or when GNSS data is not available or inaccurate.

In one aspect, GNSS measurements are used to achieve more accurate three-dimensional (3D) velocity with higher availability. In another aspect, a neural network-based method is used to detect wheel slips and the No-Wheel-Left-Behind algorithm is used to strategically select the right wheel speed measurement in many scenarios, further improving the robustness of the algorithm even during GNSS outages. In yet another aspect, a GNSS rejection and recovery mechanism is used, including the known normalized innovation square (NIS) metric and trajectory shape-matching technique in combination with a new trajectory shape-matching technique that helps the localization algorithm recognize correct measurements by comparing the trajectory generated by its kinematic model against a GNSS data point.

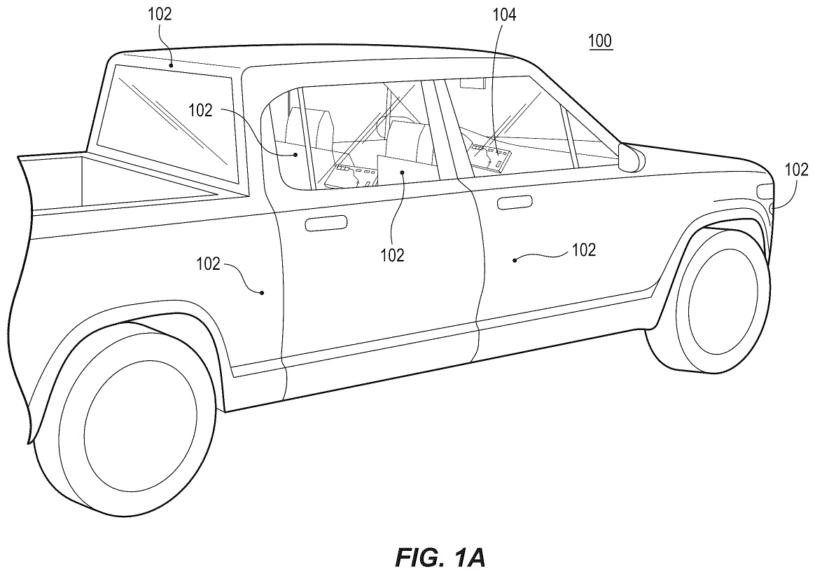

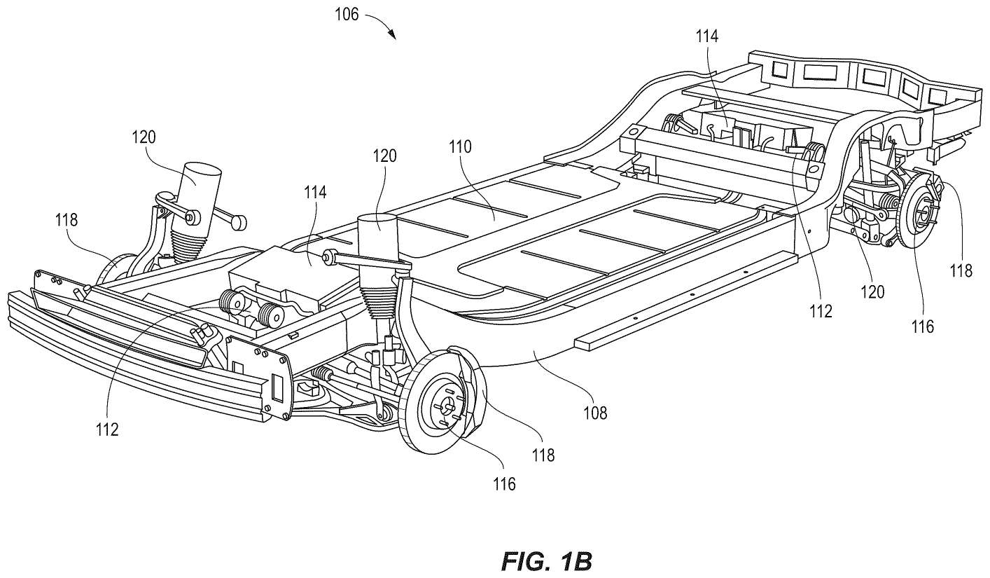

FIG. 1A illustrates an example vehicle 100. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (i.e., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear reduction drive. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the one or more drive units 112 by one or more sets of power electronics 114. The power electronics 114 may include inverters configured to convert direct current (DC) from the battery 110 into alternating current (AC) supplied to the motors of the one or more drive units 112.

The one or more drive units 112 are coupled to two or more hubs 116 to which wheels may mount. Each hub 116 includes a corresponding brake 118, such as the illustrated disc brakes. The one or more drive units 112 or other components may also provide regenerative braking. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIGS. 1B and 1n the discussion below, the vehicle 100 is a battery electric vehicle. However, the systems and methods disclosed herein may be used for any type of vehicle, including vehicles powered by an internal combustion engine (ICE), hybrid drivetrain, hydrogen fuel cell drivetrain, or other type of drivetrain that requires heating in preparation for use, such as diesel engines.

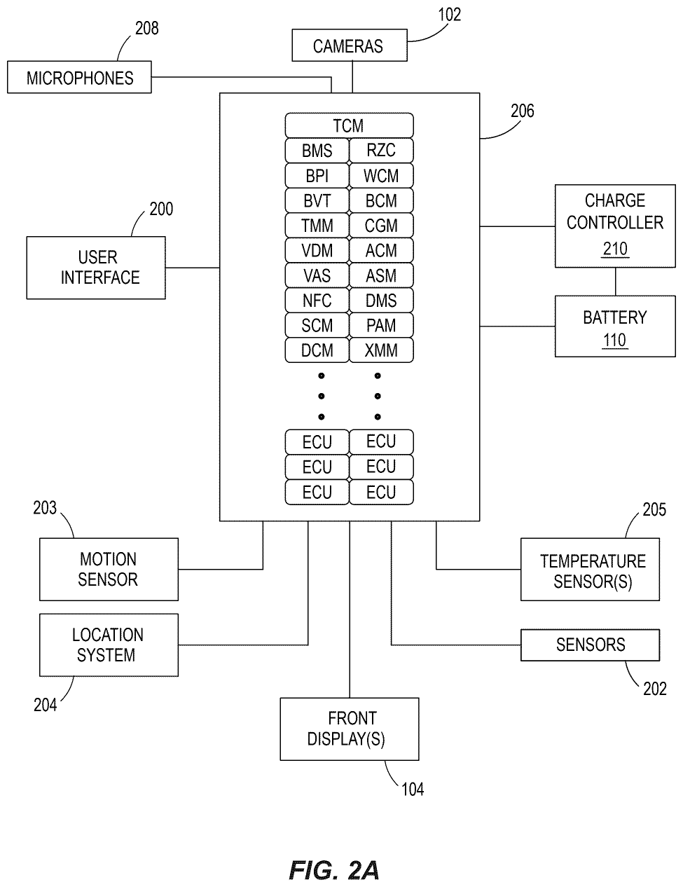

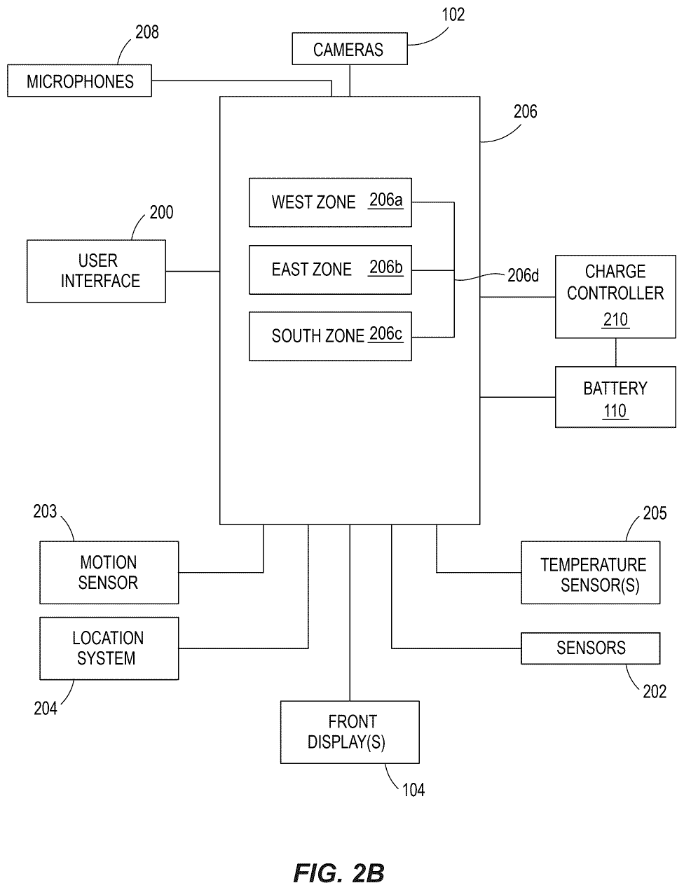

FIG. 2A illustrates example components of the vehicle 100 of FIG. 1A. As shown in FIG. 2A, the vehicle 100 includes the cameras 102, the one or more front displays 104, a user interface 200, one or more sensors 202, a motion sensor 203, and a location system 204. The one or more sensors 202 may include ultrasonic sensors, radio detection and ranging (RADAR) sensors, light detection and ranging (LIDAR) sensors, or other types of sensors. The motion sensor 203 may include wheel speed sensors sensing the speed of each wheel of the vehicle 100. The motion sensor 203 may include one or more or other sensors in the drivetrain of the vehicle 100. The motion sensor may also include an inertial measurement unit (IMU) (e.g., a six axis accelerometer and possibly a magnetic compass). The location system 204 may be implemented as a global navigation satellite system (e.g., global positioning system (GPS)) receiver. The user interface 200 allows a user, such as a driver or passenger in the vehicle 100, to provide input.

The components of the vehicle 100 may include one or more temperature sensors 205. The temperature sensors 205 may include sensors configured to sense an ambient air temperature, temperature of the battery 110, temperature of power electronics 114, temperature of each drive unit 112 and/or each motor of each drive unit 112, temperature in a cabin of the vehicle, temperature of coolant, or the temperature of any other component of the vehicle 100.

A control system 206 executes instructions to perform at least some of the actions or functions of the vehicle 100, including the functions described below. For example, as shown in FIG. 2, the control system 206 may include one or more electronic control units (ECUs) configured to perform at least some of the actions or functions of the vehicle 100, including the functions described below. In certain embodiments, each of the ECUs is dedicated to a specific set of functions. Each ECU may be a computer system and each ECU may include functionality described below.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle's communications hub that connects and transfers data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102 and sensors 202. The sensor signals collected by the CGM ECU are then communicated to the appropriate ECUs for performing, for example, the operations and functions described below.

The control system 206 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU. If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 208, etc.) to the TCM ECU.

The control system 206 may be coupled to a charge controller 210. The charge controller 210 may receive electrical current from a current source and supply the current to the battery 110. The supply of current to the battery may be further managed by the BMS, which controls the rate of charging of the battery 110 to avoid overheating or other harm that may shorten the life of the battery 110.

Referring to FIG. 2B, in some embodiments, the control system 206 may be implemented as a plurality of zonal controllers 206a, 206b, 206c. Each zonal controller 206a, 206b, 206c may control a subset of systems of the vehicle. The subset of systems controlled by each zonal controller 206a, 206b, 206c may be generally assigned based on location within the vehicle 100. For example, a west zonal controller 206a may control systems on a driver side of the vehicle 100, an cast zonal controller 206b may control systems on a passenger side of the vehicle 100, and a south zonal controller 206c may control systems in a rear portion of the vehicle. Each zonal controller 206a, 206b, 206c may implement a portion of the functions ascribed to the ECUs of the control system 206 of FIG. 2A. The functions of the ECUs may be distributed among the zonal controller 206a, 206b, 206c such that only one zonal controller 206a, 206b, 206c implements the functions of each ECU. Alternatively, the functions of an ECU may be duplicated across multiple zonal controllers 206a, 206b, 206c, each zonal performing the functions of the ECU for the portion of the vehicle to which that zonal controller 206a, 206b, 206c is assigned.

The zonal controllers 206a, 206b, 206c may be connected to one another by a network 206d, such as an Ethernet network, controller area network (CAN), or other type of network.

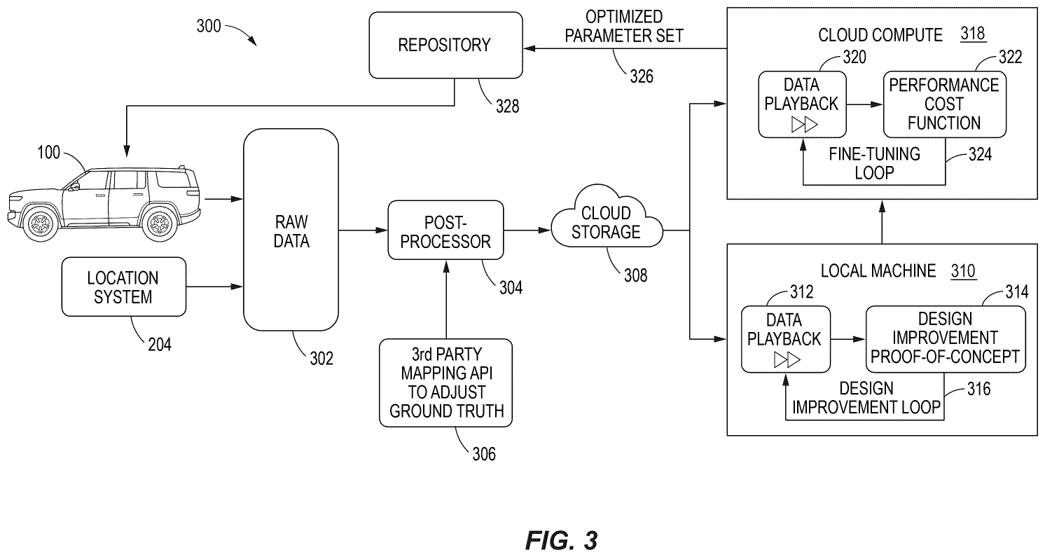

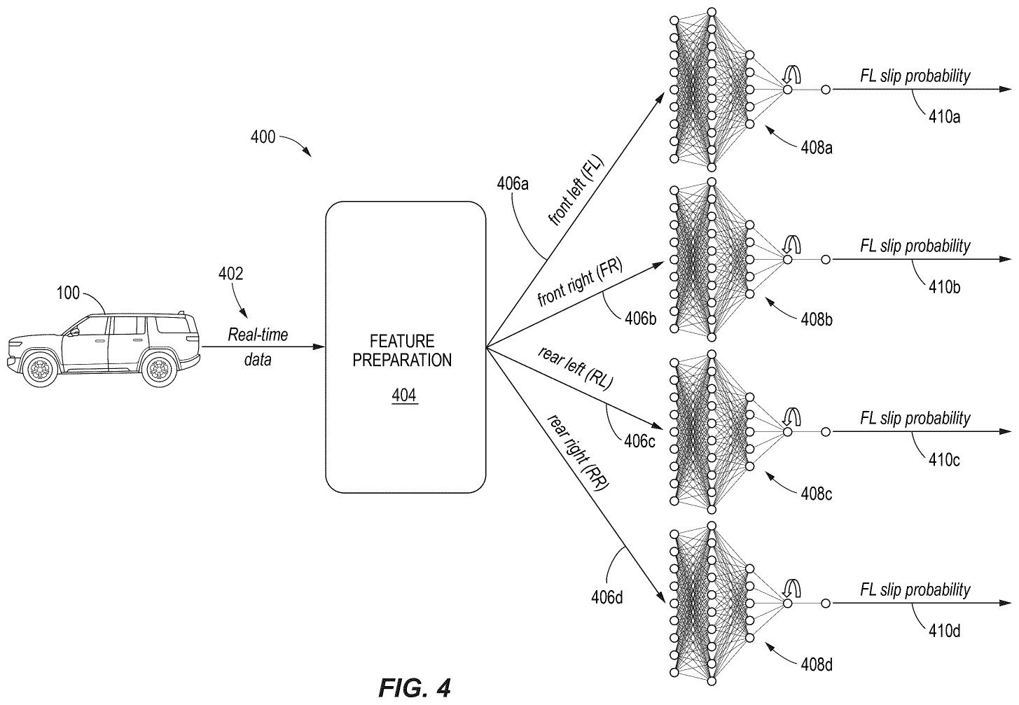

Referring to FIG. 3, a machine learning model (see FIG. 4 and corresponding description) may be used to detect wheel slip, which may then be used to perform localization of the vehicle 100. FIG. 3 illustrates a system 300 for collecting training data and training the machine learning model. The system 300 may collect raw data 302 from one or more components of the vehicle 100. The raw data 302 may include outputs of sensors sensing vehicle dynamics, such as outputs of the motion sensor 203, which may include wheel speed measurements from wheel speed sensors or measurements of the speed of some other component in the drivetrain of the vehicle and outputs of the IMU, such as acceleration about one or more translational or rotational axes (e.g., a six axis accelerometer) and/or an orientation according to a magnetic compass. The raw data 302 may further include outputs of the location system 204, such as in the form of GNSS data (e.g., GNSS coordinates).

When training the machine learning model, ground truth data may be collected as the vehicle 100 is driven and the ground truth data may be included with the other data included in the raw data 302 as described above. The ground truth data may be captured using additional instruments mounted to the vehicle 100 that may not be present on a production vehicle, such as optical, inertial, or other sensors for detecting the true velocity of the vehicle 100 in at least two dimensions, yaw rate, and/or other dynamic values.

The raw data 302 may be input to a post-processor stage 304, which may trim the raw data and add vehicle metadata to obtain post-processed data. Trimming may include removing irrelevant data from the raw data 302, such as while the vehicle is stopped. Vehicle metadata may describe a circumstance in which the raw data 302 was captured, such as a current drive mode of the vehicle, ambient temperature, weather data, rain sensor outputs, a road type (e.g., from map data) the vehicle 100 was driving on, suspension information (e.g., compression and extension of each suspension 120 over time), steering inputs from a driver, accelerator and braking inputs from the driver, and/or other data.

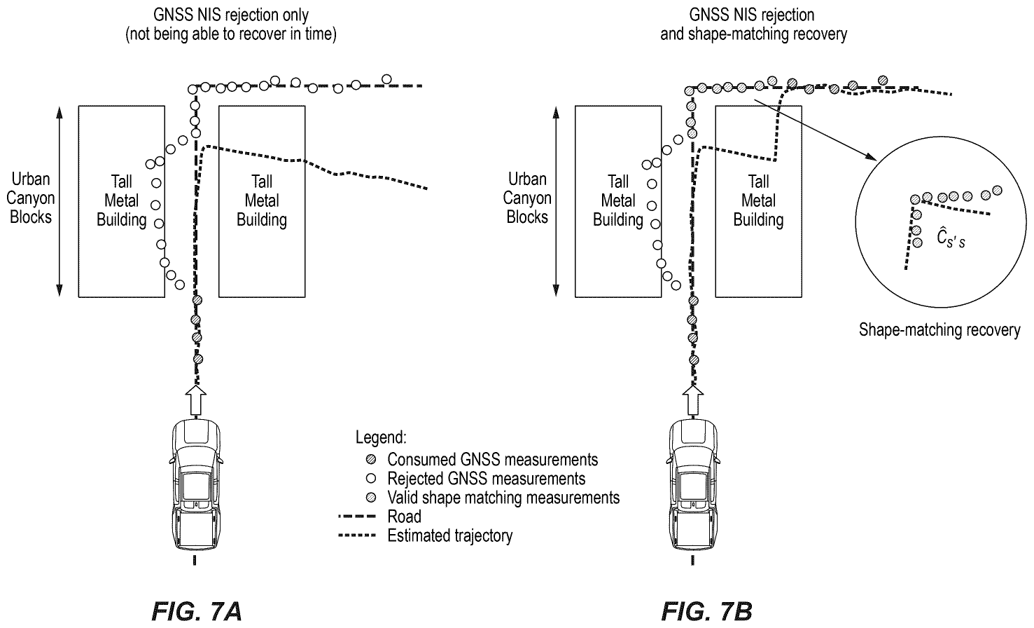

In some embodiments, ground truth data from the location system 204 may be adjusted in the post-processor stage 304 with the adjusted ground truth data being included in the post-processed data. For example, a mapping application programming interface (API) 306, such as a commercially available API from a third party, may be used to adjust the ground truth. Adjusting the ground truth data may include compensating for errors in GNSS coordinates due to reflections or poor reception using map data, e.g., assume the vehicle 100 is following roads indicated in map data to remove coordinates that indicate deviation from roads. The mapping API 306 may implement an approach for rejecting GNSS coordinates described below with respect to FIGS. 7A and 7B.

The post-processed data may be stored for later use, such as in cloud storage 308 or on-premise storage. The post-processed data may be used by a local machine 310, e.g., on-premise server or other computing device, to design and configure a machine learning model to detect wheel slip or perform other task, such as autonomous driving or driving assistance.

For example, the post processed data may be processed by a data playback stage 312. The data playback stage 312 may stream the post-processed data to simulate receipt of the post-processed data by the control system 206 of a vehicle 100. Time stamps or other timing data included in the post-processed data may be used to stream data from various sources (motion sensor 203, location system 204, steering wheel, accelerator pedal, drive mode selector etc.) that approximates the timing that the data was received by the control system 206 of the vehicle 100 that captured the post-processed data.

The streamed data may be processed in a design stage 314. The design stage 314 may process the streamed data with respect to a machine learning model and evaluate outputs of the machine learning model with respect to ground truth in the streamed data. The design stage 314 may enable the architecture and other parameters of the machine learning model to be adjusted. The design stage 314 may be used to improve a design of the machine learning model and perform proof-of-concept testing. A design improvement loop 316 may be implemented by which the streamed data is iteratively processed with the machine learning model following each adjustment to the machine learning model. The performance of the machine learning model may be measured according to similarity between the output and the ground truth in the streamed data.

Further refinement of the machine learning model may be performed on a cloud computing platform 318. A data playback stage 320 executing in the cloud computing platform 318 may stream the post-processed data to simulate receipt of the post-processed data by the control system 206 of a vehicle 100, such as in the manner described above with respect to the data playback stage 312.

The streamed data may be processed in a performance cost function stage 322. The performance cost function stage 322 may implement a training algorithm that processes the streamed data with the machine learning model, evaluates outputs of the machine learning model with respect to ground truth in the streamed data (e.g., GNSS data) according to a performance cost function. A fine-tuning loop 324 may update the machine learning model according to the performance cost function. The processing of the data playback stage 320, performance cost function stage 322, and fine-tuning loop 324 may be repeated as an iterative loop with respect to the same or different streamed data in order to train the machine learning model to perform an intended task, e.g., identifying wheel slip as described below. This iterative loop enables continuous improvement of the machine learning model while preventing regressions.

The machine learning model may be represented as an optimized parameter set 326 and may be sent to a repository 328, such as a git repository. The machine learning model may be merged with software updates or other data transmitted to a vehicle 100, such as using an over-the-air (OTA) update. The vehicle 100 receives the optimized parameter set 326 and implements the machine learning model according to the optimized parameter set in order to perform the tasks that the machine learning model was trained to perform.

FIG. 4 illustrates an example wheel slip detection machine learning model 400 (hereinafter “machine learning model 400”) that may be used to detect wheel slip. The machine learning model may include a feature preparation stage 404 that receives real-time data from the control system 206 of the vehicle, such as some or all of the data described above as being included in the raw data 302.

The feature preparation stage 404 may output features 406a, 406b, 406c, 406d, corresponding to the front left (FL), front right (FR), rear left (RL), and rear right (RR) wheels of the vehicle 100, respectively. The features 406a, 406b, 406c, 406d corresponding to a wheel may include a wheel speed measurement from a wheel speed sensor of the motion sensor 203 measuring the speed of that wheel. The features may further include outputs of other sensors, such as GNSS data, IMU measurements, or vehicle metadata as defined above.

The features 406a, 406b, 406c, 406d may be input to neural networks 408a, 408b, 408c, 408d. Each neural network may be trained to predict wheel slip of one wheel of the vehicle 100. The neural networks 408a, 408b, 408c, 408d may each be implemented as a deep neural network (DNN) recurrent neural network (RNN), or convolution neural network (CNN). The neural networks 408a, 408b, 408c, 408d may likewise be substituted for another form of machine learning model.

Wheel slip is not uncommon in electric vehicles due to their acceleration capabilities. It occurs when the actuator torque applied to the wheel exceeds the friction torque provided by the surface, leading to excessive acceleration or deceleration of the wheel compared to the vehicle's acceleration or deceleration. This results in a mismatch between the vehicle speed and the rotational speed of the tire. The slip ratio, is calculated according to (1), where @ is the rotational speed, R is the tire rolling radius, and vis the vehicle speed.

$$λ = \frac{ω \times R - V}{V} \qquad ( 1 )$$

The tractive force capability of a wheel drops significantly as the surface becomes more slippery, making it easier for the actuator torque to exceed the friction torque, leading to wheel slip. To achieve peak acceleration, a slip ratio of about 20 percent may be required.

Accurately detecting slip on low-friction surfaces (ice, snow, sand, gravel, etc.) enables inaccurate wheel speed measurements to be handled when performing vehicle localization. Excessive wheel slip may be defined as slipping when the difference between its rotational velocity and translational velocity (in the direction the wheel points toward) exceeds 0.1, 0.2, or 0.3 m/s (approximately 1 km/h), or some other predefined value. Using the approach described herein, wheel slip is estimated without the use of GNSS data to provide a robust solution.

When a wheel slips excessively, the wheel loses traction and the vehicle 100 can become uncontrollable. Traction control systems (TCS) and anti-lock braking systems (ABS) are common in most modern vehicles and are designed to limit wheel slip. For these systems to function effectively, these systems must have a good estimate of the vehicle speed to compute wheel slip. However, the wheel speed is also a crucial measurement for any vehicle speed estimator algorithm. Using the difference between the estimated vehicle speed and the wheel speed to detect slip can introduce a circular dependency issue. For example, when the vehicle 100 decelerates under low-friction conditions, the TCS will attempt to control the wheel speed below the estimated vehicle speed to maintain a negative slip ratio and generate negative tractive force. However, if the vehicle speed estimator uses the wheel speed measurements in this scenario, the vehicle speed estimate will also be pulled down, leading to the wheel speed being controlled by the TCS to an even lower target. This positive feedback loop is a consequence of the circular dependency. Additionally, as mentioned earlier, we must be able to detect wheel slip accurately with or without GNSS due to the safety-critical nature of the problem.

Based on observations of wheel speed and wheel torque data alone, some indicators of wheel slip can be observed, such as:
If the wheel speed measurements significantly differ from each other, it is more likely that some wheels are slipping.
If the actuator torque on a wheel is small enough, as time approaches infinity, the probability of that wheel slipping approaches zero. This is because any wheel slip would introduce a counteracting friction force until there is no slip. The only exception is when the friction coefficient is zero.
Among all forward-driven wheels (positive net actuator torque), the slowest wheel has the smallest probability of slipping because forward-driven wheels should have a positive slip ratio, and thus, the slowest wheel is the closest to the vehicle speed.
Conversely, among all of the negatively driven wheels (negative net actuator torque), the fastest wheel has the smallest probability of slipping for the same reason.

However, these cues are not accurate in all scenarios. Using the machine learning model 400 trained with data for a wide variety of scenarios, more accurate estimates of wheel slip may be obtained. In some embodiments, the feature preparation stage 404 may identify features 406a, 406b, 406c, 406d in the real-time data 402 that relate to wheel slip of each wheel that are then processed using the neural networks 408a, 408b, 408c, 408d, respectively, to estimate the wheel slip of each wheel. Examples features that may be included in the features 406a, 406b, 406c, 406d are listed in Table 1.

TABLE 1
Features used for wheel slip detection and reasons for use.

| Feature | Reasoning |
|---|---|
| Wheel speed | Direct indicator of slip via rate of change. |
| Wheel speed | Helpful for detecting slip when wheels have |
| differences | unequal speeds. |
| relative to | |
| other wheels | |
| Wheel torque | Reveals load and force applied to the wheel- |
| | ground interface. |
| Wheel acceleration | Helps distinguish between normal motion and |
| | slip events. |
| Torque threshold | Detects slip near the threshold by tracking |
| counter | torque levels. |
| Accelerometer | Provides dynamic motion data to detect forces |
| measurements | from slip. |

In some embodiments, before calculating the differences in wheel speed, a transformation may be applied to the speed of each wheel (e.g., the output of a wheel speed sensor) to remove the kinematic contributions from body rotation, particularly addressing the yaw effect. This adjustment ensures that the neural networks 408a, 408b, 408c, 408d do not confuse wheel speed differences caused by yaw motion with actual wheel slip. The adjustments to each wheel speed may be derived according to (2), in which the adjustments (V_{ω,fl}, V_{ω,fr}, V_{ω,rl}, V_{ω,rr}) are calculated from: measured velocity Vₓ (e.g., along the x (back-to-front) direction of the vehicle 100 as measured by the IMU or as estimated by a Kalman filter as discussed below); velocity V_{y} (e.g., along the y (left-to-right) direction of the vehicle 100 as measured by the IMU or as estimated by a Kalman filter as discussed below); a yaw rate (i); terms d_{fl,y}, d_{fr,y}, d_{rl,y}, d_{rr,y} representing the distances from the IMU to the wheels in the y-direction for the front-left (fl), front-right (fr), rear-left (rl), and rear-right (rr) wheels; terms d_{fa, x} and d_{ra,x} represent the distances from the IMU to the front and rear axles in the x-direction, respectively; and terms θ_{fl}, θ_{fr}, θᵣₗ, θᵣᵣ, denote the wheel angles of the front-left, front-right, rear-left, and rear-right wheels, respectively. In some embodiments, the effects of roll and pitch rotations are not considered as they are assumed to be absorbed by the suspensions 120.

$${V}_{ω , f l} = ( {V}_{x} + {d}_{f l , y} \dot{φ} ) cos ( {θ}_{f l} ) + ( {V}_{y} + {d}_{fa , x} \dot{φ} ) sin ( {θ}_{fl} ) {V}_{ω , fr} = ( {V}_{x} + {d}_{fr , y} \dot{φ} ) cos ( {θ}_{fr} ) + ( {V}_{y} + {d}_{fa , x} \dot{φ} ) sin ( {θ}_{fr} ) {V}_{ω , r l} = ( {V}_{x} + {d}_{rl , y} \dot{φ} ) cos ( {θ}_{r l} ) + ( {V}_{y} + {d}_{r a , x} \dot{φ} ) sin ( {θ}_{r l} ) {V}_{ω , r r} = ( {V}_{x} + {d}_{rr , y} \dot{φ} ) cos ( {θ}_{rr} ) + ( {V}_{y} + {d}_{ra , x} \dot{φ} ) sin ( {θ}_{rr} ) \qquad ( 2 )$$

Each neural network 408a, 408b, 408c, 408d may have one of several designs. For example, the design may include a recurrent neural network (RNN) since the data being processed is time-series data. For example, the RNN may be implemented using the approach described in Medsker, L. R., Jain, L., et al. (2001) (Recurrent Neural Networks Design and Applications, 5 (64-67), 2), which is hereby incorporated herein by reference in its entirety. RNNs may advantageously be used where the vehicle 100 has enough computing and memory resources to provide real-time inferences.

In another example, the design includes a single large multi-layer perceptron (MLP). For example, the MLP described in Taud and Mas (2018) (Taud, H., & Mas, J.-F. (2018). Multilayer perceptron (MLP). Geomatic approaches for modeling land change scenarios, 451-455), which is hereby incorporated herein by reference in its entirety. In Taud and Mas, four wheel-slip probabilities are produced according to (3) and (4).

The approach of Taud and Mas is improved according to the approach in two aspects. First, four separate MLPs are used (e.g., one MLP in each neural network 408a, 408b, 408c, 408d) to process the features for each wheel (e.g., as shown in FIG. 4). These separate MLPs may be smaller than a single MLP trained to process the features for all four wheels as in the approach of Taud and Mas and require less computational effort, even in view of the computations performed by the feature preparation stage 404. Second, a custom layer (5) is added before the final sigmoid layer (6) of each MLP. Experiments conducted by the inventors have shown that slip events usually exhibit autocorrelation properties. This custom layer functions similarly to a first-order low-pass filter, carrying information from a previous prediction of the MLP, as a hidden state, to the current prediction of the MLP.

$${h}^{( l )} = ϕ ( {W}^{( l )} {h}^{( l - 1 )} + {b}^{( l )} ) \qquad ( MLP forward pass ) ( 3 )$$

$$ϕ ( z ) = max ( 0 , z ) \qquad ( ReLu activation ) ( 4 )$$

$${h}_{t}^{( l )} = ( 1 - w ) \cdot {h}^{( l - 1 )} + w \cdot {h}_{t - 1}^{( l )} \qquad ( Custom layer forward pass ) ( 5 )$$

$$y = σ ( z ) = \frac{1}{1 + {e}^{- z}} \qquad ( Sigmoid activation ) ( 6 )$$

In (3) to (6), the MLP includes a network with a plurality of layers/and a pre-activation value z; h^{(l)}, W^{(l)}, and b^{(l)} are the output, the weight matrix, and the bias vector, respectively, of layer l;

$${h}_{t}^{( l )}$$

is the output at time step t of the custom layer l; w is the trainable weight parameter r; and y is the output of the network.

The neural networks 408a, 408b, 408c, 408d take the features relating to each wheel and return the wheel slip probability 410a, 410b, 410c, 410d, respectively, of each wheel. In some embodiments, the neural networks 408a, 408b, 408c, 408d may use Adam optimization and a binary cross entropy loss function in which positive labels are weighted more than negative ones. This approach may be used because the consequence of a false negative is much more severe than that of a false positive from a safety standpoint. Due to the run-time constraint (e.g., less than 0.25 ms of execution time), the neural networks 408a, 408b, 408c, 408d may be relatively small, consisting of less than 100, less than 80, less than 70, or 60 neurons spread across 8 or less, 7 or less, or 6 layers in each MLP.

In experiments conducted by the inventors, the training data used to train the neural networks 408a, 408b, 408c, 408d was equivalent to more than 5,000 miles of limit-driving on low-friction surfaces, ensuring that the neural networks 408a, 408b, 408c, 408d learn from a diverse set of challenging conditions. Most of the training data was collected with velocity ground truth instrumentation. For data that did not have ground truth velocity, the velocity was computed from post-processing. Once the ground truth velocity is obtained, labeling the wheel slip flag is a straightforward process of transforming the ground truth velocity (Vₓ) and the wheel speed (V_{w}) to the same location and direction, and comparing the difference according to (7), where wheel slip=1 indicates an acceptable amount of wheel slip and wheel slip=0 indicates excessive wheel slip, e.g., wheel speed will be ignored.

$$wheel slip = \vert {V}_{x} - {V}_{w} \vert < slip threshold \qquad ( 7 )$$

The training data may be generated such that the training data includes the most difficult wheel slip cases along with a mix of less difficult and normal driving scenarios. The testing data set may include all of the difficult wheel slip cases and some normal driving data. Normal driving data are included to ensure the MLP doesn't become overly sensitive. Conversely, in various embodiments, all difficult cases are included in the training data to ensure the MLP is cautious enough to handle the corner cases.

To evaluate the performance of the machine learning model 400, training and testing were performed using labeled vehicle dynamics data. The machine learning model 400 demonstrated strong classification performance, achieving an accuracy of 92.9% on the training set and 94% on the test set. This suggests good generalization and no significant overfitting. In terms of classification breakdown, the model achieved a true positive ratio (TPR) of 92.5% and a true negative ratio (TNR) of 94.4% indicating robust detection of both slip and non-slip events.

Notably, the wheel slip events exhibited temporal continuity, meaning that once a wheel slip event occurs, it typically lasts for more than 1 second rather than being a brief, isolated occurrence. Leveraging this characteristic, we can incorporate a time-debounce mechanism to improve the TPR. For example, adding a 0.5-second positive-to-negative time debounce increases the TPR to 98.61% at the expense of reducing the TNR to 84.1%. This approach aligns with prioritizing the reduction of missed detections of wheel slip events.

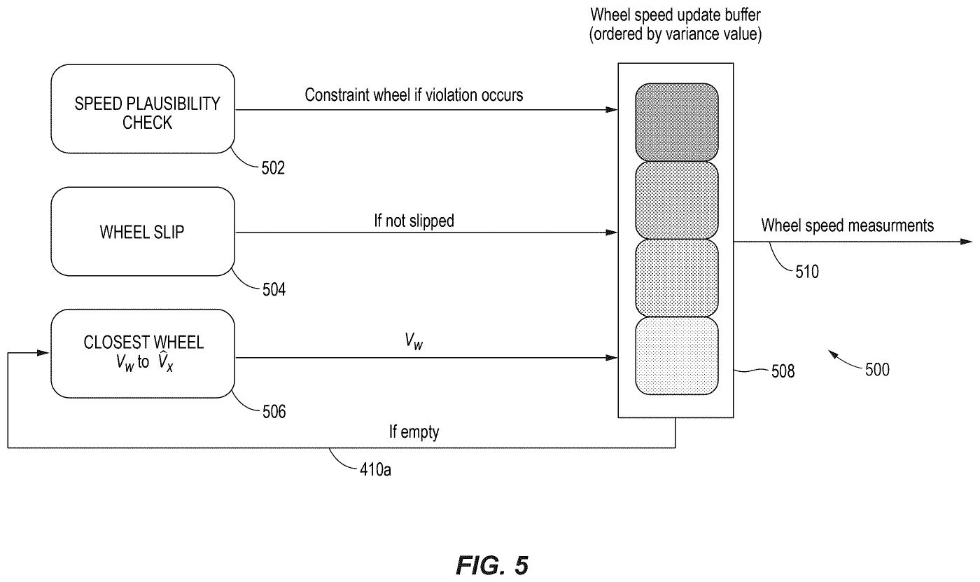

FIG. 5 illustrates an example use for wheel slip such as may be determined using the machine learning model 400. In some embodiments, a Kalman filter, such as an extended Kalman filter (EKF) may be used to perform vehicle localization. The Kalman filter may receive inputs from various sources and account for past localization estimates to estimate a location of the vehicle 100. The inputs may include GNSS data from the location system 204 and IMU data from the motion sensor 203. The inputs may further include one or more wheel speed measurements, such as one or more wheel speed measurements selected using the wheel speed selector system 500 (hereinafter “system 500”) shown in FIG. 5.

When driving aggressively, it is challenging to determine which wheel speed measurement should be used for a Kalman filter update. It is also possible for all wheels to slip, resulting in no accurate wheel speed measurement. However, this does not mean that the Kalman filter should disregard all wheel speed measurements. In fact, performing a measurement update on a measurement that can pull the state closer to the actual ground truth is still beneficial even if one does not know exactly where the ground truth is. The goal of the “no wheel left behind” algorithm is to identify such a wheel speed measurement. The system 500 may include a speed plausibility check 502, a wheel slip calculation 504, and a closest wheel selection stage 506.

The speed plausibility check 502 may include determining the driving state of each wheel. Each wheel can have three driving states:
Forward driven—the wheel experiences significant positive actuator torque.
Backward driven—the wheel experiences significant negative actuator torque.
Neutral—the force is too small to determine.

To determine the driving state, a leaky-bucket may be used to accumulate the net actuator torque T_{accu} applied to each wheel and T_{accu} may be compared it to a threshold, such as according to Algorithm 1 below.

Algorithm 1 State Transition Based on Threshold

```
if T_{accu} > threshold then
  state ← FORWARD DRIVEN
else if T_{accu} < threshold then
  state ← BACKWARD DRIVEN
else
  state ← NEUTRAL
end if
```

To determine the driving state, a leaky-bucket may be used to accumulate the net actuator torque T_{accu} applied to each wheel and T_{accu} may be compared it to a threshold, such as according to Algorithm 1, above. Let W_{f} and W_{b} be the lists of forward and backward driven wheels, respectively, as determined by Algorithm 1. For a tire to generate a tractive force in a direction, the tire needs to slip in the same direction as the tractive force. In other words, if a wheel is accelerating the vehicle forward, its rotational speed must be equal to or higher than its translational speed to generate a positive slip. Assuming there is zero noise on the wheel speed signal, the forward driven wheels, backward driven wheels, and wheel speed must meet the condition of (8).

$$max ( {W}_{b} ) \leq h ( \hat{x} ) \leq min ( {W}_{f} ) \qquad ( 8 )$$

Here h(\hat{x}) is a Kalman filter measurement function that transforms the estimated velocity states into linear wheel speeds, such as the approach shown in (2). In a transition phase where the applied torque is changing direction, there may be forward-driven wheel(s) that are slower than the backward-driven wheel(s), meaning min(W_{f})<max(W_{b}). In such cases, the violation of the condition of (8) can be ignored. Otherwise, when a violation occurs, (8) can be treated as a state constraint in the Kalman filter and incorporated as a “perfect measurement” with relatively low variance.

A constraint wheel may be selected as part of the plausibility check. During accelerating, the slowest forward-driven wheel (min(W_{f})) may be used as the constraint wheel. During decelerating, the fastest rearward-driven wheel ((max(W_{b})) may be used as the constraint wheel. In the case that a violation of (8) occurs, only the wheel speed of the constraint wheel is output from the speed plausibility check 502 and appended to a measurement update list 508. In the case that no violation of (8) occurs then no wheel speed measurement is appended to the measurement update list 508.

The wheel slip calculation 504 may include estimating wheel slip states, such as using the machine learning model 400. If a wheel is flagged as not slipping (i.e. slip probability less than 50% as determined by the machine learning model 400), the wheel speed measurement of that wheel is appended to the measurement update list 508, otherwise the wheel speed measurement of that wheel is not appended. The wheel slip calculation 504 can add at most four wheel speed measurements to the measurement update list 508 if no wheel is slipping. If all four wheels are found to be slipping, then no wheel speed measurement is added to the measurement update list 508 as a result of the wheel slip calculation 504.

If the measurement update list 508 is empty after the processing of the speed plausibility check 502 and the wheel slip calculation 504, then the closest wheel selection stage 506 may be used to select a wheel speed measurement to add to the measurement update list. The wheel speed measurement added may be that which is closest to the estimated vehicle speed, e.g., as estimated by the Kalman filter or based on measurements of the IMU.

As described above, no wheel speed measurements are added to the measurement update list 508 when the condition of (8) is met and all four wheels are slipping. Even if all four wheels are slipping, over time, the wheels should still track relatively close to the vehicle speed (e.g., the most recent vehicle speed estimate (\hat{V}ₓ) output from the Kalman filter). On the other hand, if all wheel speed measurements are rejected and a kinematic model is projected for an extended period, accumulated error could grow unbounded. Since the vehicle speed is plausible according to (8), the measured wheel speed closest to the vehicle speed (“the selected wheel speed”) is either the slowest forward-driven wheel or the fastest backward-driven wheel, which should have the highest probability of being the closest wheel speed to the true vehicle speed. The selected wheel speed based on this criterion will tend to be associated with a relatively high value of covariance, e.g., in the covariance model defining the Kalman filter. The covariance is preferably high enough to prevent instant convergence to the wheel speed but small enough to guarantee convergence as time approaches infinity. A wheel speed measurement selected by the closest wheel selection stage 506 serves as an anchor to prevent the velocity states of the Kalman filter from propagating to infinity when none of the measured wheel speeds are accurate.

Wheel speed measurements 510 are received from the measurement update list 508 by a consumer, such as the Kalman filter or other component. Under normal driving conditions, although the estimator of the Kalman filter can use wheel speed measurements for all four wheels for the update process of the Kalman filter, using all four introduces additional computational overhead while not necessarily guarantecing better accuracy. Thus, the measurement update list 508 is ordered from lowest to highest covariance of the wheel speed measurements according to the convergence model of the Kalman filter. The Kalman filter consumes these wheel speed measurements in this order, but the number of wheel speed measurements used in the update process depends on the computing capacity.

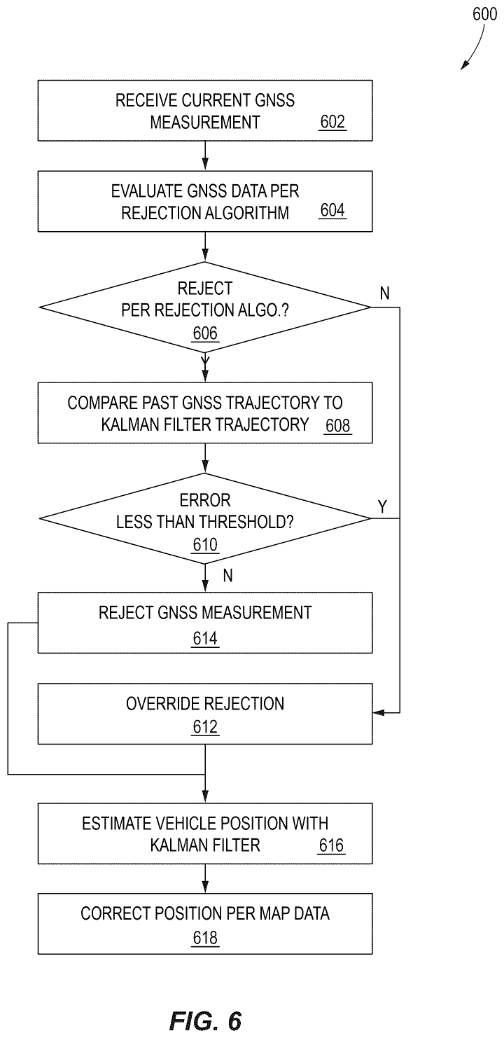

Referring to FIG. 6, in some embodiments, localization of the vehicle 100 may further be enhanced by rejecting GNSS data that is clearly erroneous, such as due to presence of the vehicle 100 in an urban canyon. One of the key uses of localization is to enable accurate navigation throughout an entire planned route. Localization based on GNSS data is particularly challenging in urban canyons. An urban canyon may be defined as a street lined with high rise buildings, such as San Francisco, Chicago, and New York City. It is well understood that these high-rises block GNSS (e.g., GPS) line-of-sight signals, which in turn degrades localization performance.

Using the approach described herein, the location system 204 (e.g., GNSS receiver) and the motion sensor (e.g., wheel speed sensors and IMU) may be combined with map data using algorithms to achieve a stable and accurate navigation system. This approach allows the navigation system to be more compatible with various vehicle platforms. For the GNSS input, the algorithm may use a level one (L1) standalone three-dimensional (3D) position and velocity measurements from an automotive grade GPS receiver. More accurate (sub-meter) position inputs may be achieved using real-time kinematic (RTK) correction along with GNSS data.

A method 600 may be executed by the control system 206 to reject GNSS measurements estimated to be erroneous. The method 600 may include receiving a GNSS measurement at step 602 and evaluating the GNSS measurement at step 604 using a GNSS rejection algorithm. For example, the GNSS rejection algorithm may include the normalized innovation squared (NIS) error algorithm, such as using the NIS detector disclosed in Bar-Shalom, Y., Li, X. R., & Kirubarajan, T. (2004). Estimation with applications to tracking and navigation: Theory algorithms and software. John Wiley & Sons, which is hereby incorporated herein by reference in its entirety (hereinafter “Bar-Shalom”). The Bar-Shalom NIS detector may be defined according to (9).

$${D}_{k} = {\sum }_{j = k - q + 1}^{k} {r}_{j} {S}_{j} {r}_{j} \qquad ( 9 )$$

In (9), Dx is the test statistics at time step k, rₖ is the Kalman filter innovation vector calculated using

$${r}_{k} = {z}_{k} - h ( {\hat{x}}_{k}^{-} ) ,$$

and Sₖ is the innovation covariance calculated from

$${H}_{k} {P}_{k}^{-} {H}_{k}^{T} + {R}_{k} .$$

If Dₖ is found, at step 606, to be greater than a predefined threshold T, the current GNSS measurement from step 602 is rejected according to the NIS detector. Though the snapshot version of the NIS detector (i.e., using only a single innovation error instead of a window of innovation errors) could be viable after tuning in certain scenarios, the cumulative NIS detector is more robust in scenarios involving gradual measurement faults, such as GPS position drift.

In some embodiments, where the rejection algorithm determines that the current GNSS measurement should be rejected, further processing may be performed to avoid erroneous GNSS measurement rejections. For example, the NIS detection is a well-known erroneous measurement rejection method for the Kalman filter but can be prone to excessive rejections if the estimated states diverge significantly from the correct measurements. Though the threshold T should theoretically be computed using the inverse λ² test statistics with the desired probability of false alarm and the appropriate number of degrees of freedom, the theoretical value is rarely effective in practice. Thus, tuning the right rejection threshold often involves a trade-off between performance in urban canyons (where measurements are often corrupted, making rejections necessary) and overall robustness (against over-rejection).

To mitigate this, the method 600 may include comparing, at step 608, a past GNSS trajectory with a trajectory output by the Kalman filter. If an error indicated by the comparison is found, at step 610, to be less than a threshold, the rejection of the current GNSS measurement at step 604 is overridden at step 612. If not, the current GNSS measurement is rejected at step 614. An example implementation of steps 608 and 610 are described in greater detail below.

The comparison of step 608 may include aligning the past GNSS-derived trajectory with a propagated trajectory from the Kalman filter. Step 608 may include evaluating the shape similarity by computing the Euclidean distances between corresponding trajectory points. The algorithm used at step 608 may include the approach described in Kabsch, W. (1978) (A discussion of the solution for the best rotation to relate two sets of vectors. Acta Crystallographica Section A: Crystal Physics, Diffraction, Theoretical and General Crystallography, 34 (5), 827-828), which is hereby incorporated herein by reference in its entirety (hereinafter “Kabsch”). Kabsch discloses minimizing the root mean squared deviation between two paired sets of points P and Q, each containing N points in R². The approach of Kabsch may include translating the centroid of each set of points to the origin according to (10) and (11), where μ_{P} and μ_{Q} are the centroid coordinat of the P and Q sets of points, respectively.

$$\overline{P} = P - {μ}_{P} \qquad ( 10 )$$

$$\overline{Q} = Q - {μ}_{Q} \qquad ( 11 )$$

The approach of Kabsch may include computing a covariance matrix H according to (12), computing a singular value decomposition (SVD) of H according to (13), computing an optimal rotation matrix according to (14), and computing a normalized shape error according to (15), where qₖ and pₖ are rows in Q̅ and P̅, respectively, and L is the length of the shorter trajectory of the past GNSS trajectory and the projected trajectory from the Kalman filter.

$$H = {\overline{P}}^{T} \overline{Q} \qquad ( 12 )$$

$$H = US {V}^{T} \qquad ( 13 )$$

$$C = U [ \begin{matrix}1 & 0 & 0 \\ 0 & 1 & 0 \\ 0 & 0 & det ( {UV}^{T} )\end{matrix} ] V \qquad ( 14 )$$

$$e = \frac{1}{L} {\sum }_{k = 1}^{N} \vert {Cq}_{k} - {p}_{k} \vert \qquad ( 15 )$$

If the error (e) is found to be less than an error threshold at step 610, then the GNSS measurement is used, at step 612, to update the Kalman filter. Otherwise, the GNSS measurement is rejected at step 614. If the error is less than the error threshold, it is likely that the GNSS measurement is correct again. Step 612 may include overwriting the NIS-based measurement rejection mechanism and allowing the Kalman filter to resume consuming GNSS updates. Note that an accumulated trajectory buffers for past GNSS measurements and Kalman filter projections that is used for shape matching can be either distance-based or time-based.

FIGS. 7A and 7B illustrate how NIS rejection and shape-matching recovery work together. FIG. 7A shows standard NIS rejection and FIG. 7B shows NIS rejection with shape-matching recovery. In FIG. 7A, it can be seen that the estimated trajectory keeps rejecting the GNSS measurements even when they become correct around the turning corner. This rejection of valid GNSS measurements is due to the significant accumulation of innovation error in the test statistics Dₖ, causing a prolonged recovery time for the Kalman filter. On the other hand, FIG. 7B shows that the shape-matching algorithm recognizes the matching 90-degree corner and informs the Kalman filter that the GNSS measurements are likely correct again, resulting in faster recovery. One key point is that the shape-matching algorithm is only activated when the GNSS measurements are low quality and the position variances of the GNSS measurements are high. Experiments conducted by the inventors have shown that the combination of GNSS NIS rejection and shape-matching recovery is simple and effective, performing particularly well in grid-like cities such as San Francisco (SF) and New York City (NYC).

Referring again to FIG. 6, the GNSS measurement as well as other sensor data (e.g., wheel speed measurements selected per FIG. 5) may be processed by the Kalman filter at step 616 to obtain a position estimate for the vehicle 100. The Kalman filter may generate an estimated trajectory including a past trajectory and a projected trajectory of the vehicle 100.

In some embodiment, the estimated trajectory is not the final trajectory used for some purposes, such as for displayed on a front display 104 providing navigation guidance. For example, at step 618, the estimated trajectory may be corrected according to map data. For example, a map API may perform a correction to align the estimated trajectory with the boundaries of a road on which the vehicle 100 is determined by the map API to be located if the estimated trajectory does not fall within the boundaries of the road. The road may be identified as being on a route for which the map API is providing navigation guidance. For example, the map API may align the estimated trajectory with the center of the nearest road (e.g., lane of a road), provided the estimated trajectory is sufficiently close to the actual road without violating one or more predefined rules. The additional information about the center of the nearest road helps further enhance position estimates, particularly in challenging environments. For example, when significant drift is detected due to GNSS corruption in urban canyons, the map-matched location may be used as an additional measurement by the Kalman filter or subsequent localization algorithm to improve robustness.

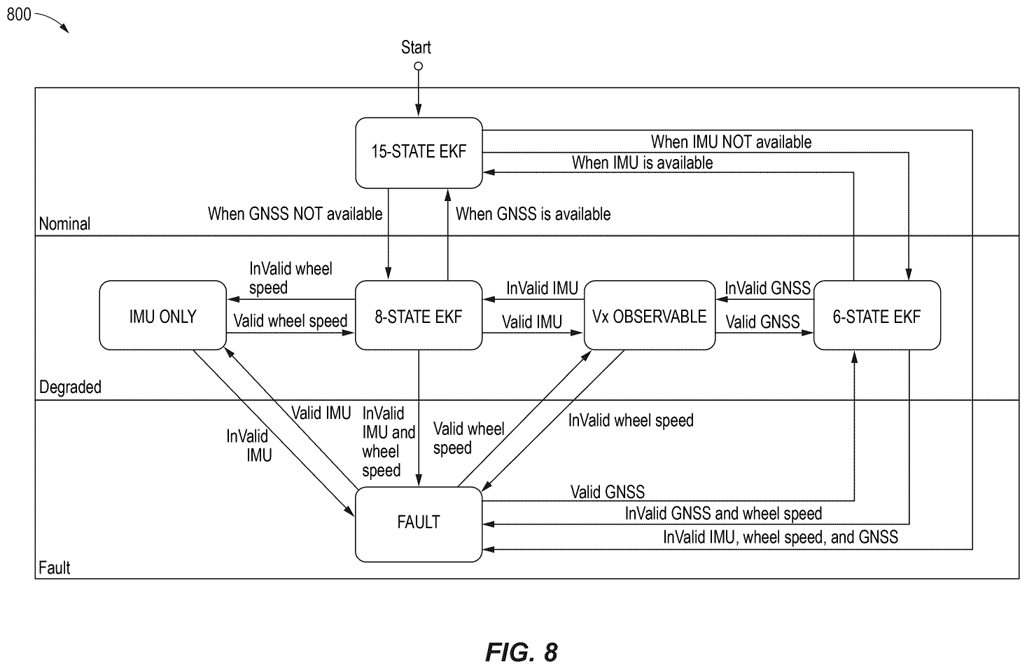

FIG. 8 illustrates a localization state machine 800 that may be used to select which measurements (wheel speed measurements, GNSS measurements, IMU measurements, etc.) will be used to perform localization. To ensure continuous localization operation across various sensor availability scenarios, the localization state machine 800 may dynamically adjust the matrices of the estimator of the Kalman filter based on the available sensor data. The states range from a fully observable 15-state configuration to degraded modes when only some sensor data are available and a fault mode when no measurements are available. This flexibility ensures that the estimator remains functional and provides increased availability for all of consumers of localization data under a large range of circumstances.

In the illustrated embodiment, the localization state machine 800 has six possible modes in three categories: nominal, degraded, and fault. By default, the localization state machine 800 starts in the 15-state mode when all sensors are available and a 15-state extended Kalman filter (EKF) is used as the Kalman filter according to any of the approaches described herein. The 15 states may include 3 degrees of freedom (DOF) attitude, position, and velocity; 6 DOF IMU biases; four wheel-speed measurements from wheel speed sensors; and two-dimensional GNSS measurements. When certain sensors become unavailable, the localization state machine switches to modes in the degraded categories, where only a subset of the 15 states can be estimated. These degraded states include an 8-state EKF mode, IMU only mode, Vx-observable mode, and 6-state EKF mode. In the 8-state mode, the estimator of the EKF uses the IMU measurements and the wheel speed measurements, 3 DOF velocity, roll, pitch, and 3 DOF gyroscope biases. In IMU only mode, the estimator continues propagating the states of the estimator using its kinematic model. The Vx observable mode estimates only longitudinal velocity Vₓ, while the 6-state EKF mode estimates the 3 DOF position and velocity states. All nominal and degraded states can transition to a Fault mode when the sensor in that state is no longer suitable for operation.

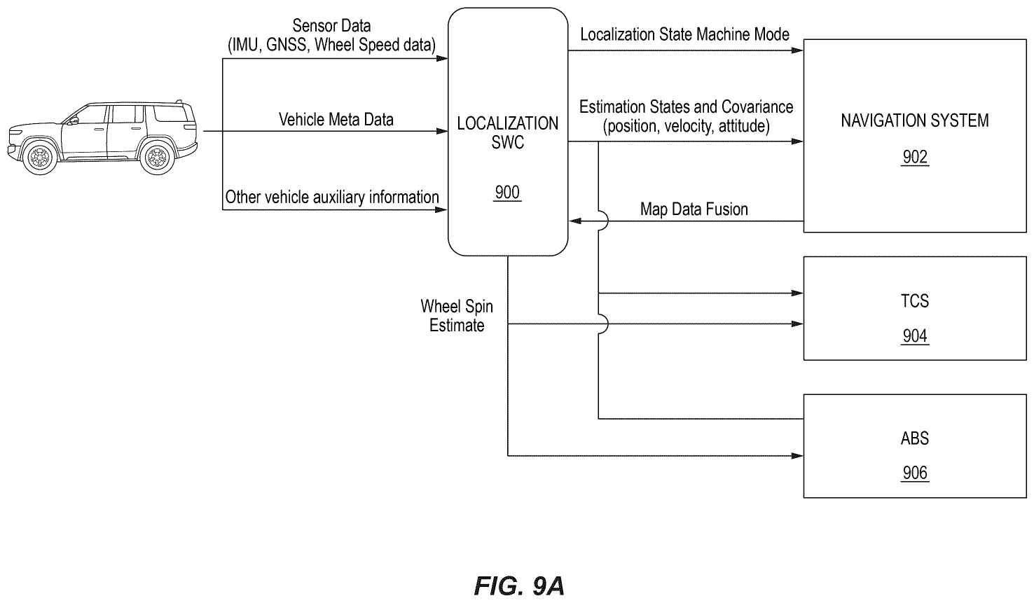

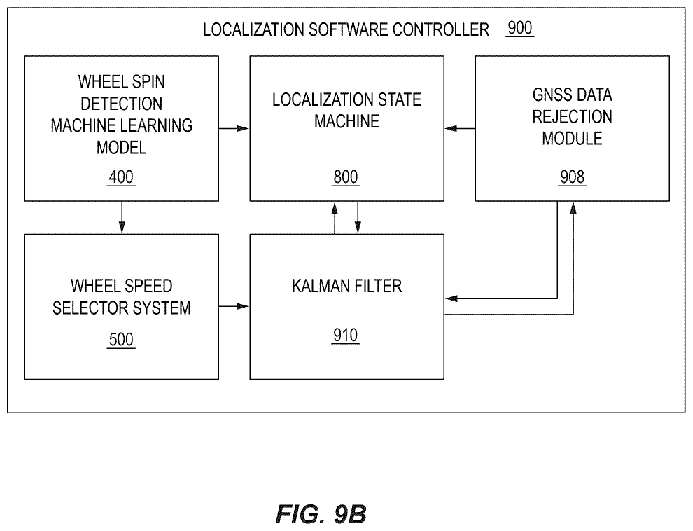

Referring to FIGS. 9A and 9B, the systems and methods described above with respect to FIGS. 4 to 8 may be implemented by a localization software controller (SWC) 900, which itself may be part of the control system 206, such as in the form of one or more ECUs of the control system 206. The localization SWC 900 may receive sensor data, such as wheel speed measurements and IMU data from the motion sensor 203 and GNSS data from the location system 204. The localization SWC 900 may further receive vehicle metadata as described above with respect to FIG. 3 and possibly other vehicle auxiliary information. The localization SWC 900 may output such information as a localization state machine mode (e.g., the current mode of the localization state machine 800), estimated states, and covariance of the states (e.g., states may include position, velocity, and attitude). The localization SWC 900 may further output wheel spin estimates as determined using the wheel spin detection machine learning model 400.

The outputs of the localization SWC 900 may be used by the control system 206 to control operation of the vehicle 100. For example, the control system 206 may include a navigation system 902 that receives the outputs in order to update navigation guidance and a representation of the location of the vehicle on a map. The navigation system 902 may output map data fusion, e.g., a corrected estimated trajectory based on map data (see step 618 of the method 600 and corresponding description) that is received by the localization SWC 900 to implement the method 600.

Other consumers of outputs of the localization SWC 900 may include a traction control system (TCS) 904, which may use the estimated states and wheel spin estimates to make interventions to reduce rollover risk or other unstable operation of the vehicle 100. The anti-lock braking system (ABS) 906 may receive the estimated states and the wheel spin estimates and use them to control brakes 118 of the vehicle 100 to maintain traction.

Referring specifically to FIG. 9B, the localization SWC 900 may include the wheel spin detection machine learning model 400 and the wheel speed selector system 500, which receives the wheel spin estimates of the wheel spin detection machine learning model 400 and processes the wheel spin estimates as described above with respect to FIG. 5. A GNSS rejection module 908 may implement the method 600 and indicate, to the localization state machine 800, whether a current GNSS measurement should be used to update the Kalman filter 910. The wheel spin estimates may further be input to the localization state machine 800. The wheel spin estimates, the output of the GNSS rejection module 908, and the quality of the outputs of other sensors as described above with respect to FIG. 8 may then be used by the localization state machine 800 to determine the mode of operation of the Kalman filter 910.

The Kalman filter 910, which may be an EKF, operates in the mode directed by the state machine 800 and uses the wheel speed measurements output by the wheel speed selector system 500, GNSS measurements that are not rejected by the GNSS rejection module 908, and the output of other sensors, such as the IMU, in order to generate the estimated states as directed by the localization state machine 800. An estimated trajectory generated by the Kalman filter 910 may be input to the GNSS rejection module 908 and used according to the method 600. Likewise, the current estimated velocity of the vehicle 100 as generated by the Kalman filter 910 may be used by the wheel speed selector system 500 to select the closest wheel speed (see wheel selection stage 506 of FIG. 5 and corresponding description).

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a one or more computer processing devices. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Certain types of storage devices that include these mediums include: diskette, hard disk, random access memory (RAM), read only memory (ROM), erasable programmable read only memory (EPROM or Flash memory), static random access memory (SRAM), compact disc read only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, refers to non-transitory storage rather than transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but the storage device remains non-transitory during these processes because the data remains non-transitory while stored.

While the foregoing is directed to embodiments of the present disclosure, other and further embodiments may be devised without departing from the basic scope thereof, and the scope thereof is determined by the claims that follow.

What is claimed is:

1. A method comprising:
calculating, by a control system and via a plurality of neural networks, a plurality of wheel slip estimates for a plurality of wheels of a vehicle based on a plurality of wheel speed measurements, the calculating comprising, for each wheel of the plurality of wheels of the vehicle:
receiving, a wheel speed measurement of the plurality of wheel speed measurements derived from an output of a wheel speed sensor of the each wheel; and
processing the wheel speed measurement with one or more sensor outputs of the vehicle with a neural network of the plurality of neural networks corresponding to the each wheel to obtain a wheel slip estimate of the plurality of wheel slip estimates corresponding to the each wheel; and
controlling, by the control system, operation of the vehicle according to the plurality of wheel slip estimates.

2. The method of claim 1, wherein the one or more sensor outputs include outputs of an inertial measurement unit.

3. The method of claim 1, wherein the one or more sensor outputs include global navigation satellite system (GNSS) data.

4. The method of claim 1, wherein the one or more sensor outputs include both of outputs of an inertial measurement unit (IMU) and global navigation satellite system (GNSS) data.

5. The method of claim 1, wherein each neural network of the plurality of neural networks each includes eight or less layers.

6. The method of claim 1, wherein each neural network of the plurality of neural networks includes six layers.

7. The method of claim 1, wherein each neural network of the plurality of neural networks is a multi-layer perceptron (MLP).

8. The method of claim 7, wherein the MLP of each neural network of the plurality of neural networks includes a customer layer before a sigmoid layer, the customer layer configured to carry information from a previous prediction as a hidden state to a current prediction of the MLP of each neural network of the plurality of neural networks.

9. The method of claim 1, wherein controlling operation of the vehicle according to the plurality of wheel slip estimates comprises processing one or more wheel speed measurements of the plurality of wheel speed measurements using a Kalman filter, the one or more wheel speed measurements being selected from the plurality of wheel speed measurements according to the plurality of wheel slip estimates.

10. The method of claim 9, further comprising, selecting, by the control system, the one or more wheel speed measurements according to plausibility of the plurality of wheel speed measurements with respect to a vehicle speed output from the Kalman filter, the plurality of wheel slip estimates, and closeness of the plurality of wheel speed measurements to the vehicle speed output from the Kalman filter.

11. A vehicle control system configured to:
calculate, via a plurality of neural networks, a plurality of wheel slip estimates for a plurality of wheels of a vehicle based on a plurality of wheel speed measurements, the calculating comprising, for each wheel of the plurality of wheels of the vehicle:
receiving a wheel speed measurement of the plurality of wheel speed measurements derived from an output of a wheel speed sensor of the each wheel; and
processing the wheel speed measurement with one or more sensor outputs of the vehicle with a neural network of the plurality of neural networks corresponding to the each wheel to obtain a wheel slip estimate of the plurality of wheel slip estimates corresponding to the each wheel; and
control operation of the vehicle according to the plurality of wheel slip estimates.

12. The vehicle control system of claim 11, wherein the one or more sensor outputs include outputs of an inertial measurement unit.

13. The vehicle control system of claim 11, wherein the one or more sensor outputs include global navigation satellite system (GNSS) data.

14. The vehicle control system of claim 11, wherein the one or more sensor outputs include both of outputs of an inertial measurement unit (IMU) and global navigation satellite system (GNSS) data.

15. The vehicle control system of claim 11, wherein each neural network of the plurality of neural networks each includes eight or less layers.

16. The vehicle control system of claim 11, wherein each neural network of the plurality of neural networks is a multi-layer perceptron (MLP).

17. The vehicle control system of claim 16, wherein the MLP of each neural network of the plurality of neural networks includes a customer layer before a sigmoid layer, the customer layer configured to carry information from a previous prediction as a hidden state to a current prediction of the MLP of each neural network of the plurality of neural networks.

18. The vehicle control system of claim 11, wherein the vehicle control system is further configured to control operation of the vehicle according to the plurality of wheel slip estimates by processing one or more wheel speed measurements of the plurality of wheel speed measurements using a Kalman filter, the one or more wheel speed measurements being selected from the plurality of wheel speed measurements according to the plurality of wheel slip estimates.

19. The vehicle control system of claim 18, wherein the vehicle control system is further configured to select the one or more wheel speed measurements according to plausibility of the plurality of wheel speed measurements with respect to a vehicle speed output from the Kalman filter, the plurality of wheel slip estimates, and closeness of the plurality of wheel speed measurements to the vehicle speed output from the Kalman filter.

20. A vehicle comprising:
a plurality of wheels;
a plurality of wheel speed sensors each configured to sense a speed of a wheel of the plurality of wheels;
one or more other sensors including one or more of an inertial measurement unit (IMU) or a global navigation satellite system (GNSS) receiver; and
a control system including a plurality of neural networks, the control system configured to:
calculate a plurality of wheel slip estimates for the plurality of wheels using the plurality of neural networks by, for each wheel of the plurality of wheels:
receiving, a wheel speed measurement derived from an output of a wheel speed sensor of the each wheel; and
processing the wheel speed measurement with outputs of the one or more other sensors with a neural network of the plurality of neural networks corresponding to the each wheel to obtain a wheel slip estimate of the plurality of wheel slip estimates corresponding to the each wheel; and
control operation of the vehicle according to the plurality of wheel slip estimates.
